(19) United States
(12) Patent Application Publication
(10) Pub. No.: US 2007/0229661 A1
(43) Pub. Date: Oct. 4, 2007

(54) Object detecting system and method

(75) Inventors: Hiroshi Aoki, Tokyo (JP); Masato Yokoo, Tokyo (JP); Yuu Hakomori, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/730,703

(22) Filed: Apr. 3, 2007

(30) Foreign Application Priority Data
Apr. 4, 2006 (JP) 2006-103626

(51) Int. Cl. H04N 7/18; E05F 15/00; B60Q 1/00

(52) U.S. Cl. 348/148; 348/135; 701/45; 340/425.5

(57) ABSTRACT

An object detecting system for detecting information about objects on vehicle seats utilizes a camera having a single view point, which is effective for conducting a rationalized setting for the viewing field of the camera. According to the setting for the viewing field of the camera in an object detecting system which is installed in a vehicle, respective halves of the object on the driver seat and the object on the front passenger seat are covered by the viewing field of the camera.

### BACKGROUND

The present invention relates to an occupant information detecting system to be installed in a vehicle and, more particularly, to a technology for detecting information about objects on vehicle seats.

Conventionally, there are known various technologies for detecting information about an object occupying a vehicle seat by using a photographing mechanism such as a camera. For example, Japanese Patent Unexamined Publication No. 2003-294855 (“JP '855) discloses a configuration of an occupant detecting apparatus in which a single camera arranged in front of a vehicle occupant is used to detect the position of the vehicle occupant (which is incorporated by reference herein in its entirety).

### SUMMARY

One embodiment relates to an object detecting system for detecting information about objects on vehicle seats. The object detecting system comprises: a camera for taking images from a single view point in a cabin of a vehicle toward a rear side of the vehicle; and a processing mechanism for deriving information about the objects on the vehicle seats based on images taken by the camera. The viewing field of the camera covers an area defined between a first sight line extending from the single view point toward the rear side of the vehicle through a central area in the lateral direction of the driver seat and a second sight line extending from the single view point toward the rear side of the vehicle through a central area in the lateral direction of the front passenger seat.

Another exemplary embodiment relates to an operation device control system. The operation device control system comprises: an object detecting system; an operation device; and an actuation control mechanism for controlling the actuation of the operation device. The object detecting system includes: a camera for taking images from a single view point in a cabin of a vehicle toward a rear side of the vehicle; and a processing mechanism for deriving information about the objects on the vehicle seats based on images taken by the camera. The viewing field of the camera covers an area defined between a first sight line extending from the single view point toward the rear side of the vehicle through a central area in the lateral direction of the driver seat and a second sight line extending from the single view point toward the rear side of the vehicle through a central area in the lateral direction of the front passenger seat. The operation device is operated based on the information about the object on the vehicle seat derived by the processing mechanism of the object detecting system.

Yet another embodiment relates to a vehicle. The vehicle comprises: an engine/running system; an electrical system; an actuation control device for conducting the actuation control of the engine/running system and the electrical system; and an object detecting mechanism for detecting information about objects on vehicle seats. The object detecting mechanism comprises an object detecting system that includes: a camera for taking images from a single view point in a cabin of a vehicle toward a rear side of the vehicle; and a processing mechanism for deriving information about the objects on the vehicle seats based on images taken by the camera. The viewing field of the camera covers an area defined between a first sight line extending from the single view point toward the rear side of the vehicle through a central area in the lateral direction of the driver seat and a second sight line extending from the single view point toward the rear side of the vehicle through a central area in the lateral direction of the front passenger seat.

Another embodiment relates to an object detecting method for detecting information about objects on vehicle seats. The method comprises: positioning a camera in a vehicle; setting a viewing field of the camera to cover an area defined between a first sight line extending from a single view point toward the rear side of the vehicle through a central area in the lateral direction of the driver seat and a second sight line extending from the single view point toward the rear side of the vehicle through a central area in the lateral direction of the front passenger seat so that the viewing field is allocated to cover respective halves of an object on the driver seat and an object on the front passenger seat; and taking images with the camera from the single view point in a cabin of a vehicle toward a rear side of the vehicle.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an illustration showing an object detecting system according to an embodiment which is installed in a vehicle.

FIG. 2 is a plan view of a viewing field of a camera 112 of the embodiment.

FIG. 3 is a view taken along a line A-A in a direction of arrows in FIG. 2.

FIG. 4 is an illustration showing components of a vehicle according to an embodiment.

### DETAILED DESCRIPTION

It is known that an apparatus for detecting information about a vehicle occupant by using a camera like the occupant detecting apparatus disclosed in the aforementioned JP '855 is designed such that the brightness of lens is decreased as the viewing angle of the camera is increased and that a peripheral area is distorted as compared to a central area. Therefore, in the case of using a single camera to detect a plurality of occupants at once, the detection accuracy of detecting information about the vehicle occupants is deteriorated due to the darkness and distortion of image resulting from the characteristics of lens. For this, an expensive camera is required. On the other hand, in a case of using a camera having a narrow viewing angle for the purpose of improving the detection accuracy, the number of vehicle occupants which the camera can detect is reduced so that it is difficult to detect information about a predetermined number of vehicle occupants arises. Specifically, while a single camera with a limited viewing angle can detect information about a front passenger seat, it may be difficult for the camera to detect information about both the driver seat and the front passenger seat at once. In this case, it is required to use a plurality of cameras. It is therefore desired, in designing such a detection system, to provide a technology for conducting a setting for a viewing field which is effective in detecting required information about objects while using a camera with a limited viewing angle for cost reduction.

It is an object of embodiments to provide a technology, relating to an object detecting system for detecting information about objects on vehicle seats by using a camera, which is effective for conducting a rationalized setting for the viewing field of the camera having a single view point.

Though embodiments are typically adapted to an object detecting system in an automobile for detecting information about objects on vehicle seats, embodiments can be also adapted to a technology for developing an object detecting system in a vehicle other than the automobile, such as airplane, boat, train, bus, and the like.

The object detecting system of a first embodiment is an object detecting system for detecting information about objects on vehicle seats and comprises at least a camera and a processing mechanism. The “object” here used includes a vehicle occupant, an object placed on a vehicle seat, a child seat, and/or a junior seat. In embodiments, the “information about the object” widely includes information about presence, the size, the position, and the attitude of the object. When the object is a vehicle occupant, the information about the object includes the presence of a vehicle occupant, the size (physique class) of the vehicle occupant, the position of the vehicle occupant, the positions and configurations of body parts of the vehicle occupant, and the attitude of the vehicle occupant.

The camera is a mechanism (photographing mechanism or imaging mechanism) for taking images from a single view point in a cabin of a vehicle toward a rear side of the vehicle. The view point of the camera may be positioned in front of the front seats toward the rear side of the vehicle or positioned over the front seats toward the rear side of the vehicle. The “single view point” used here is a style where the number of installation places of the camera is one, that is, a single camera is mounted at a single place. As the camera capable of taking images from a single view point, a 3-D type monocular C-MOS camera or a 3-D type pantoscopic stereo camera may be employed. In addition, 2-D type camera may also be employed. In this embodiment, images of the objects on the vehicle seats are taken by the camera capable of taking images from the single view point. In the case of identifying the presence, the size, the position, and the attitude of the object based on three-dimensional images of the object, a 3-D type monocular C-MOS camera or a 3-D type pantoscopic stereo camera may be employed. In the case of detecting only the presence or absence and the outer profile (outline) of the object, a 2-D type camera may be employed.

The processing mechanism is a mechanism for deriving information about the objects on the vehicle seats based on images taken by the camera. Information about the objects on the vehicle seats is derived by this processing mechanism. In this embodiment, the processing mechanism has an image processing function of controlling the camera to obtain good quality images and for controlling the image processing for processing the taken images for analysis and a storing function of storing (recording) an operation control software, data for correction, buffer frame memory for preprocessing, defined data for recognition computing, and reference patterns.

The viewing field of the camera covers an area defined between a first sight line extending from the single view point toward the rear side of the vehicle through a central area in the lateral direction of the driver seat and a second sight line extending from the single view point toward the rear side of the vehicle through a central area in the lateral direction of the front passenger seat. In this case, the viewing field of the camera may be any field including the area defined between the first sight line and the second sight line so that the viewing field of the camera may be a field exactly corresponding to the aforementioned area or a field wider than the field including the aforementioned area. The central area in the lateral direction of the driver seat substantially coincides with the central area of an object on the driver seat and the central area in the lateral direction of the front passenger seat substantially coincides with the central area of an object on the front passenger seat. According to the viewing field, respective halves of the object on the driver seat and the object on the front passenger seat are covered by the viewing field of the camera. If the objects are vehicle occupants, a half body of an occupant on the driver seat and a half body of an occupant on the front passenger seat are covered by the viewing field.

In the case of detecting information about the object by using the camera, it is known that the brightness of lens is decreased as the viewing angle of the camera is increased and that a peripheral area is distorted as compared to a central area. Therefore, in the case of using a single camera to detect a plurality of objects at once, the detection accuracy is deteriorated due to the darkness and distortion of image resulting from the characteristics of lens. For this, an expensive camera is required. On the other hand, in the case of using a camera having a narrow viewing angle for the purpose of improving the detection accuracy, the number of objects which the camera can detect is reduced so that a problem that it is difficult to detect information about a predetermined number of objects arises. For this, in exemplary embodiments, the viewing field is set such that respective halves of the object on the driver seat and the object on the front passenger seat are covered by the viewing field of the camera. That is, the entire viewing angle of the camera is limited as much as possible and the limited viewing field of the camera is allocated such that respective halves of the object on the driver seat and the object on the front passenger seat are covered by the viewing field of the camera.

In the case that the driver seat and the front passenger seat are movable or slidable in the anteroposterior direction of the vehicle, the viewing field of the camera may be set such that respective halves of the object on the driver seat and the object on the front passenger seat are covered by the viewing field in a state that the driver seat and the front passenger seat are set at their anteriormost positions.

According to the setting for the viewing field, the viewing angle of the camera is limited, thereby reducing the cost and improving the detection accuracy of the object. In addition, the limited viewing field is allocated to detect respective halves of the objects, thereby accurately detecting information about the object on the driver seat and the object on the front passenger seat. This is based on the assumption that the object is an occupant. Since a human being has substantially a right-left symmetrical profile, the entire body of the occupant can be estimated as long as images of the half body of the occupant are accurately detected, thereby obtaining information about the entire body with high detection accuracy of a similar level.

Therefore, according to this structure of the object detecting system of the first embodiment, the viewing angle of the camera is limited, thereby reducing the cost and improving the detection accuracy of the object. By making an effective use of the limited field, desired information about object can be obtained and rationalized setting for viewing field of the camera is achieved.

Information about the object(s) detected by the object detecting system of this embodiment is suitably used for controlling an occupant restraining mechanism for restraining a vehicle occupant, such as an airbag device, a seat belt device, and a warning apparatus for outputting warning signals (display, sound and so on). As far as the “single view point” is concerned, this embodiment comprises a single camera having a single view point which is set to take images toward vehicle seats and this embodiment is not intended to avoid installation of another camera or view point for another purpose.

In the object detecting system of a second embodiment having the structure as disclosed in the first embodiment, the viewing field of the camera defined between the first sight line and the second sight line covers an area of a rear seat. According to the structure of the object detecting system of the second embodiment, desired information about an object on the rear seat can be obtained in addition to the object on the driver seat and the object on the front passenger seat.

In this embodiment, it is preferable that a sight line passing through the center of the viewing field of the camera substantially coincides with the area of the rear seat. The central area of the viewing field of the camera is an area where image hardly becomes dark and is hardly distorted because of the characteristics of lens. While the rear seat is far from the camera as compared to the front seats, the detection is conducted with no deterioration because the central area of the viewing field of the camera is bright and is hardly distorted. According to the structure, not only information about the objects on the front seats but also information about an object on the rear seat can be accurately detected.

In the object detecting system of a third embodiment having the structure as described in the first or second embodiment, the viewing angle of the viewing field of the camera when seen from above is set to be lower than about 110 degrees because it is not necessary to cover all areas of the driver seat and the front passenger seat by the viewing field of the camera.

According to the structure of the object detecting system of the third embodiment, the viewing angle of the camera is set to be lower than about 110 degrees, thereby allowing the use of an inexpensive lens having average size and brightness and thus allowing the reduction in cost of the system.

In the object detecting system of a fourth embodiment having the structure as described in any of the first-third embodiments, the processing mechanism detects respective halves of the object on the driver seat and the object on the front passenger seat based on the images obtained by the camera having the viewing field defined between the first sight line and the second sight line and thereby determines at least one of the presence, the size, the position, and the attitude of each object. Typically, whether the object is present or not is determined and when it is determined that the object is present, at least one of the size, the position, and the attitude of the object may be determined.

According to the structure of the object detecting system of the fourth embodiment, at least one of the presence, the size, the position, and the attitude of each object can be determined by detecting respective halves of the object on the driver seat and the object on the front passenger seat, thereby achieving the rationalized system.

In the object detecting system of a fifth embodiment having the structure as described in any of the first-fourth embodiments, each object on the vehicle seats is identified at least based on distances from the camera to the surface of the object or the three-dimensional profile of the object.

According to the structure of the object detecting system of the fifth embodiment, the object on the vehicle seat can be identified by at least the distances from the camera to the surface of the object or the three-dimensional profile of the object.

The operation device control system of a sixth embodiment comprises at least: an object detecting system as described in any of the first-fifth embodiments, an operation device, and an actuation control mechanism. The operation device is a device which is operated based on the information about the object occupying the vehicle seat derived by the processing mechanism of the object detecting system. Examples of the operation device include a warning device for outputting warning signals, an occupant restraining device for restraining a vehicle occupant by an airbag and/or a seat belt, and a device for adjusting according to the attitude of the occupant (for example, a device of adjusting the level of a head rest of a seat). The actuation control mechanism is a mechanism for controlling the actuation of the operation device.

According to this structure, the operation device can be controlled to be actuated in a suitable mode according to detection results about the object by the processing mechanism of the object detecting system, thereby enabling detailed control for the operation device.

The vehicle of a seventh embodiment comprises at least: an engine/running system; an electrical system; an actuation control device; and an object detecting mechanism. The engine/running system is a system involving an engine and a running mechanism of the vehicle. The electrical system is a system involving electrical parts used in the vehicle. The actuation control device is a device having a function of conducting the actuation control of the engine/running system and the electrical system. The object detecting mechanism is a mechanism for detecting information about an object occupying a vehicle seat. In this embodiment, the object detecting mechanism comprises an object detecting system as described in any of the first-fifth embodiments.

According to this arrangement, there is provided a vehicle mounted with an object detecting system in which the viewing field of the camera can be reasonably set.

The object detecting method of an eighth embodiment is a method of detecting information about objects on vehicle seats by using a camera capable of taking images from a single view point in a cabin of a vehicle toward a rear side of the vehicle. As regards the setting of the camera of this object detecting method, the viewing field of the camera is set to cover an area defined between a first sight line extending from the single view point toward the rear side of the vehicle through a central area in the lateral direction of an occupant sitting in the driver seat and a second sight line extending from the single view point toward the rear side of the vehicle through a central area in the lateral direction of the front passenger seat so that the viewing field is allocated to cover respective halves of an object on the driver seat and an object on the front passenger seat. As the camera used in this method, the same camera as a component of the object detecting system of the first embodiment can be used.

According to the object detecting method of the eighth embodiment, the viewing angle of the camera is limited, thereby reducing the cost and improving the detection accuracy of the object. By making an effective use of the limited field, desired information about object can be obtained.

In the object detecting method of a ninth embodiment having the setting for the camera as described in the eighth embodiment, the viewing field of the camera defined between the first sight line and the second sight line covers an area of a rear seat. As the camera used in this method, the same camera as a component of the object detecting system of the second embodiment can be used.

According to the object detecting method of the ninth embodiment, desired information about an object on the rear seat can be obtained in addition to the object on the driver seat and the object on the front passenger seat.

In this embodiment, it is preferable that a sight line passing through the center of the viewing field of the camera substantially coincides with the area of the rear seat. The central area of the viewing field is an area where image hardly becomes dark and is hardly distorted because of the characteristics of lens. While the rear seat is far from the camera as compared to the front seats, the detection is conducted with no deterioration because the central area of the viewing field of the camera is bright and is hardly distorted. According to the structure, not only information about the objects on the front seats but also information about an object on the rear seat can be accurately detected.

In the object detecting method of a tenth embodiment having the setting as described in the eighth or ninth embodiment, the viewing angle of the viewing field of the camera when seen from above is set to be lower than about 110 degrees. As the camera used in this method, the same camera as a component of the object detecting system of the third embodiment can be used.

According to the structure of the object detecting method of the tenth embodiment, the viewing angle of the camera is set to be lower than about 110 degrees, thereby allowing the use of an inexpensive lens having average size and brightness and thus allowing the reduction in cost of the system.

In the object detecting method of an eleventh embodiment having the method as described in any of the eighth-tenth embodiments, respective halves of the object on the driver seat and the object on the front passenger seat are detected based on the images obtained by the camera having the viewing field defined between the first sight line and the second sight line and at least one of the presence, the size, the position, and the attitude of each object is determined based on the detected halves.

By using the object detecting method of the eleventh embodiment, at least one of the presence, the size, the position, and the attitude of each object can be determined by detecting respective halves of the object on the driver seat and the object on the front passenger seat, thereby achieving the rationalized method.

In the object detecting method of a twelfth embodiment having the method as described in any of the eighth-eleventh embodiments, each object on the vehicle seats is identified at least based on distances from the camera to the surface of the object or the three-dimensional profile of the object.

By using the object detecting method of the twelfth embodiment, the object on the vehicle seat can be identified by at least the distances from the camera to the surface of the object or the three-dimensional profile of the object.

As described in the above, embodiments disclose an object detecting system for detecting information about objects on vehicle seats by using a camera having a single view point, wherein the viewing field of the camera is set to cover respective halves of an object on a driver seat and an object on a front passenger seat so that the objects can be determined only by the respective halves of the objects of the driver seat and the front passenger seat, thereby achieving rationalized setting for the viewing field of the camera.

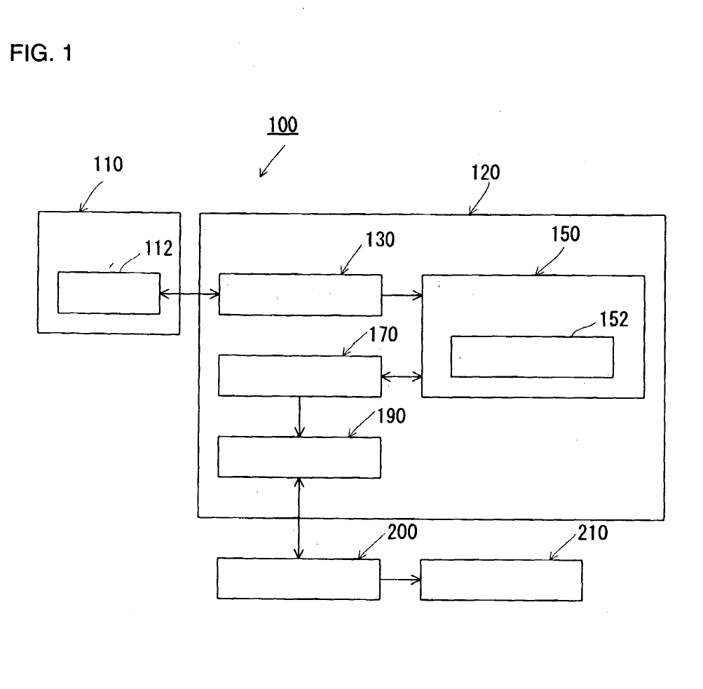

Hereinafter, description will be made as regard to embodiments with reference to drawings. First, an object detecting system 100 according to an embodiment will be described with reference to FIG. 1 through FIG. 4.

The structure of the object detecting system 100, which is installed in a vehicle, of this embodiment is shown in FIG. 1.

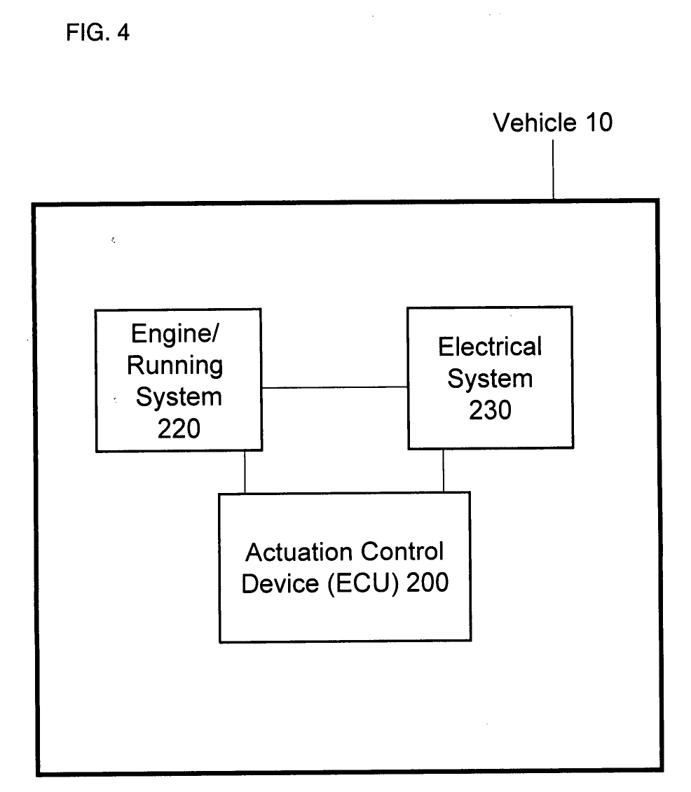

As shown in FIG. 1, the object detecting system 100 of this embodiment is installed in order to detect information about objects such as vehicle occupants in an automobile and mainly comprises a photographing mechanism 110 and a control mechanism 120. Further, the object detecting system 100 cooperates together with an ECU 200 as an actuation control device for the vehicle and an occupant restraining mechanism 210 to compose an occupant restraint apparatus for restraining an occupant in the event of a vehicle collision. The vehicle comprises, as shown in FIG. 4, an engine/running system 220 involving an engine and a running mechanism of the vehicle, an electrical system 230 involving electrical parts used in the vehicle, and an actuation control device (ECU 200) for conducting the actuation control of the engine/running system and the electrical system.

The photographing mechanism 110 of this embodiment comprises a camera 112 as the photographing device and a data transfer circuit. The camera 112 is a 3-D (three-dimensional) camera (sometimes called “monitor”) of a C-MOS or CCD (charge-coupled device) type in which light sensors are disposed into an array (lattice) arrangement. By this camera, distances relative to the object are measured a plurality of times so as to detect a three-dimensional surface profile of the object which is used to identify the presence or absence, the size, the position, and the attitude of the object. As the camera 112, a 3-D type monocular C-MOS camera or a 3-D type pantoscopic stereo camera may be employed. In case of detecting only the presence or absence and the outer profile (outline) of the object, a 2-D type camera may be employed instead of the 3-D type camera.

The camera 112 of this embodiment is mounted, in a suitable embedding manner, to an area around an inner rearview mirror, an area around a side mirror, a central portion in the lateral direction of a dashboard, or the like of the automobile in such a manner as to face one or a plurality of vehicle seats. Alternatively, the camera 112 may be mounted in a ceiling of the automobile. By using the camera 112, information about object(s) on one or more of vehicle seats such as a driver seat, a front passenger seat, and a rear seat is measured periodically a plurality of times. Mounted on the object detecting system 100 of this embodiment is a power source unit for supplying power from a vehicle buttery to the camera 112, but not particularly illustrated. The camera 112 is set to start its photographing operation when the ignition key is turned ON or when a seat sensor (not shown) installed in the driver seat detects a vehicle occupant sitting in the driver seat.

The control mechanism 120 of this embodiment further comprises at least an image processing mechanism 130, a computing mechanism (MPU) 150, a storing mechanism 170, an input/output mechanism 190, and peripheral devices (not shown). The control mechanism 120 is a mechanism of deriving information about the object on the vehicle seat based on images taken by the camera 112.

The image processing mechanism 130 is a mechanism for controlling the camera to obtain good quality images and for controlling the image processing for processing images taken by the camera 112 to be used for analysis. Specifically, as for the control of the camera, the adjustment of the frame rate, the shutter speed, and the sensitivity, and the accuracy correction are conducted to control the dynamic range, the brightness, and the white balance. As for the control of the image processing, the spin compensation for image, the correction for distortion of the lens, the filtering operation, and the difference operation as image preprocessing operations are conducted and the configuration determination and the trucking as image recognition processing operations are conducted.

The computing mechanism 150 of this embodiment comprises at least an object information extracting section 152. The object information extracting section 152 carries out a process of extracting information about the object based on the information form the image processing mechanism 130. Specifically, information about the presence, the size, the position, and the attitude of the object are extracted (derived). When the object is a vehicle occupant, the presence of a vehicle occupant, the size (physique class) of the vehicle occupant, the positions of the occupant's head, shoulder, and upper body, and whether the occupant is out-of-position (OOP) are extracted (derived).

The storage mechanism 170 of this embodiment is a mechanism for storing (recording) data for correction, buffer frame memory for preprocessing, defined data for recognition computing, reference patterns, and the computed results of the computing mechanism 150 a well as an operation control software.

The input/output mechanism 190 of this embodiment inputs information about the vehicle, information about traffic conditions around the vehicle, information about weather condition and about time zone, and the like to the ECU 200 for conducting controls of the entire vehicle and outputs recognition results. As the information about the vehicle, there are, for example, the state (open or closed) of a vehicle door, the wearing state of the seat belt, the operation of brakes, the vehicle speed, and the steering angle. In this embodiment, based on the information outputted from the input/output mechanism 190, the ECU 200 outputs actuation control signals to the occupant restraining mechanism 210 as an operation device. As the occupant restraining mechanism 210, there is, for example, an apparatus for restraining an occupant by such as an airbag and a seat belt. In addition to the occupant restraining mechanism 210, the actuation of a warning device for outputting warning signals (display, sound and so on) and/or the actuation of a device for adjusting according to the attitude of the occupant (for example, a device of adjusting the level of a head rest of a seat) may be controlled by the ECU 200.

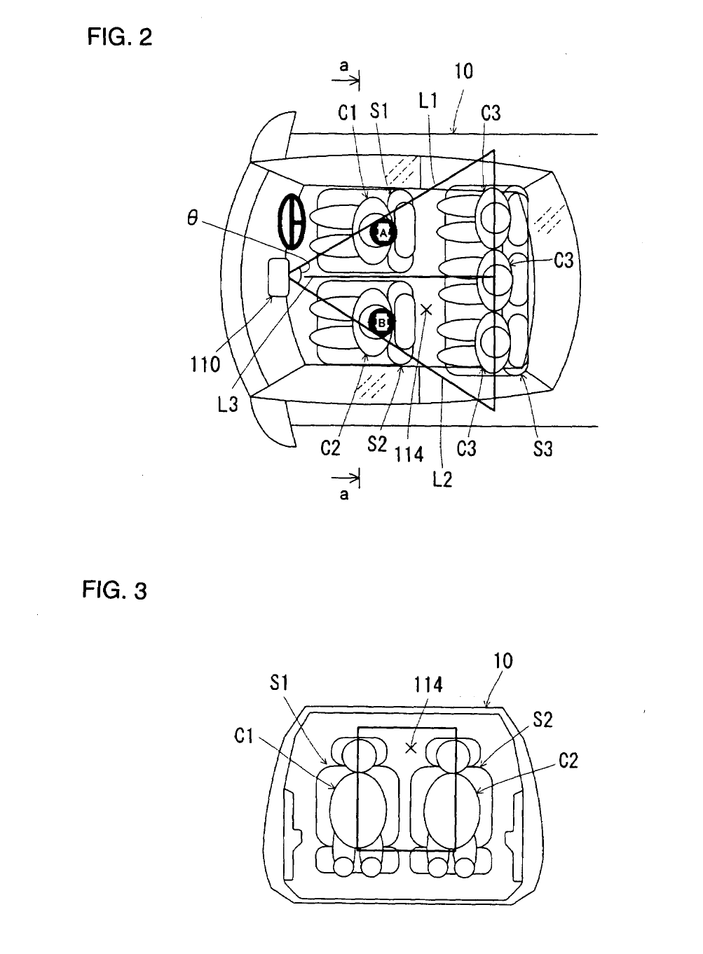

Hereinafter, the setting for viewing field of the camera 112 having the aforementioned structure will be specifically described with reference to FIG. 2 and FIG. 3. FIG. 2 shows a plan view of the viewing field 114 of the camera 112 of this embodiment and FIG. 3 is a view taken along a line a-a in a direction of arrows in FIG. 2. FIG. 2 and FIG. 3 show a case that a driver seat is on the right-hand side of a vehicle, i.e. a case of a vehicle with right-hand steering wheel.

As shown in FIG. 2 and FIG. 3, the camera 112 of this embodiment is a camera for taking images from a single view point in a cabin of the vehicle toward the rear side of the vehicle. The viewing field 114 of the camera 112 is set to cover an area defined between a sight line (first sight line L1 in FIG. 2) extending from the single view point toward the rear side of the vehicle through a central area (central area A in FIG. 2) in the lateral direction of the driver seat S1 and a sight line (second sight line L2 in FIG. 2) extending from the single view point toward the rear side of the vehicle through a central area (central area B in FIG. 2) in the lateral direction of the front passenger seat S2. In this case, the viewing field of the camera 112 may be any field including the area defined between the first sight line L1 and the second sight line L2 so that the viewing field of the camera 112 may be a field exactly corresponding to the aforementioned area or a field wider than the field including the aforementioned area. The view point of the camera 112 may be positioned in front of the front seats toward the rear side of the vehicle or positioned over the front seats toward the rear side of the vehicle, for example, when the vehicle occupants move the front seats forward.

The central area A of the driver seat S1 is defined as an area corresponding to the center of the occupant when sitting in the driver seat S1. Similarly, the central area B of the front passenger seat S2 is defined as an area corresponding to the center of the occupant when sitting in the front passenger seat S2.

In this embodiment, the viewing angle θ of the viewing field 114 when seen from above is set to be lower than about 110 degrees. This setting of the viewing angle θ of the camera 112 allows the use of an inexpensive lens having average size and brightness, thereby allowing the reduction in cost of the system. In case of using an infrared lamp as an illumination of the camera 112, the reduction in viewing angle θ allows the reduction in range to be illuminated, thereby increasing the effect of reducing the quantity of light and power consumption.

The setting of the viewing field 114 of the camera 112 as mentioned above is based on the technical idea for making efficient use of the limited viewing field while limiting the viewing angle for reducing the cost of the system. In this embodiment, the viewing field of the camera is allocated such that respective halves of the object on the driver seat and the object on the front passenger seat are covered by the viewing field of the camera 112. This is based on the idea that since a human being has substantially right-left symmetrical profile, accurate information about the entire body of the occupant can be detected as long as images of the half body of the occupant are accurately detected.

The viewing field 114 of the camera 112 covers the left half body of the occupant C1 on the driver seat S1 and the right half body of the occupant C2 on the front passenger seat S2. Therefore, information about the occupant C1 and the occupant C2 (the presence of the occupants, the sizes (physique classes), the positions of the heads, the shoulders, and the upper bodies, and the attitudes of the occupants) can be accurately detected. In this case, it is possible to detect (determine) at least one of various information about the occupant C1 and the occupant C2, typically to determine whether the occupant C1 and the occupant C2 is present or not. When it is determined that either one of the occupant C1 and the occupant C2 is present, it is possible to determine at least one of other information about the occupant.

In such a case that images corresponding to the peripheral portion of the lens of the camera 112 are used for detecting information about the occupant just like this embodiment, a free-form-surface lens is preferably used for the purpose of improving the distortion and brightness of images due to the characteristics of lens. By using such a free-form-surface lens, the quantity of light to a position corresponding to the peripheral portion of the lens can be increased and distortion can be corrected, thereby enabling further accurate detection of information about the occupant C1 and the occupant C2.

Further, the rear seat S3 is covered by the viewing field 114 (the viewing field 114 defined between the first sight line L1 and the second sight line L2 covers the area of the rear seat S3) and a sight line L3 passing through the center of the viewing field of the camera 112 substantially coincides with the area of the rear seat S3. The central area of the viewing field of the camera 112 is an area where image hardly becomes dark and is hardly distorted because of the characteristics of lens. While the rear seat is far from the camera 112 as compared to the front seats, the detection is conducted with no deterioration because the central area of the viewing field of the camera is bright and is hardly distorted. Therefore, not only information about the occupants on the front seats but also information about an occupant C3, for example, the presence or absence, the size (physique class), the position, and the attitude of the occupant C3, and whether the occupant C3 is an adult or a child, can be detected. In this case, it is possible to detect (determine) at least one of various information about the occupant C3, typically to determine whether the occupant C3 is present or not. When it is determined that the occupant C3 is present, it is possible to determine at least one of other information about the occupant C3.

Information detected by the object detecting system 100 having the aforementioned structure is transmitted to the ECU 200 shown in FIG. 1 continuously or at regular time intervals so that the ECU 200 control the actuation of the occupant restraining mechanism 210. For example, the restraining performance (occupant restraining mode) by the occupant restraining mechanism 210 such as an airbag device and a seat belt device is altered according to the presence, the physical the size, the position, and the attitude of a vehicle occupant. Specifically, the physique classes of the occupant C1 on the driver seat S1 and the occupant C2 on the front passenger seat S2 are estimated based on the information about the sizes and the positions of the occupants C1 and C2 as information about the occupant C1 on the driver seat S1 and the occupant C2 on the front passenger seat S2. Then, according to the estimated physique class, the restraining performance (occupant restraining mode) can be controlled to be altered by changing the energy absorbing capacity of the airbag and/or the seat belt and/or changing the deployment speed of the airbag. Further, the physique class of the occupant C1 may be estimated based on the information of the position of the occupant C1 as the information about the occupant C1 on the driver seat S1 and, according to the estimated physique class, the energy absorbing capacity of the airbag and/or the seat belt may be changed and/or the deployment speed of the airbag may be changed, thereby achieving the control for altering the restraining performance (occupant restraining mode).

According to this embodiment, a control of actuating the occupant restraining mechanism 210 only when there is a vehicle occupant on any of the vehicle seats is enabled by detecting the presence of the vehicle occupant on the vehicle seat. Therefore, undesired actuation of the occupant restraining mechanism 210 can be prevented. When the presence of vehicle occupants on the front seats (the driver seat S1 and the front passenger seat S2) and the rear seat S3 are detected, a control of urging the occupant(s) not wearing a seat belt to wear the seat belt by the warning device which outputs warning signals (display, sound and so on) may also be conducted.

As mentioned above, according to the object detecting system 100 of this embodiment, the detection accuracy of the vehicle occupant can be improved even with reducing the cost by using the camera 112 having limited viewing angle. In addition, the limited viewing field is allocated to cover respective halves of the object C1 on the driver seat S1 and the object C2 on the front passenger seat S2, whereby accurately detecting information about the object C1 on the driver seat S1 and the object C2 on the front passenger seat S2 so as to achieve rationalized setting for viewing field of the camera 112.

Further, according to the object detecting system 100 of this embodiment, the sight line L3 passing through the center of the viewing field of the camera 112 substantially coincides with the area of the rear seat S3 so that the body of the occupant C3 is positioned in the central area of the viewing field of the camera 112, thereby also enabling accurate detection of desired information about the occupant C3 on the rear seat S3.

Further, according to the object detecting system 100 of this embodiment, the viewing angle of the camera 112 is set to be lower than about 110 degrees, thereby allowing the use of an inexpensive lens having average size and brightness and thus allowing the reduction in cost of the system.

Further, according to the object detecting system 100 of this embodiment, the occupant restraining mechanism 210 is controlled to be actuated in a suitable mode according to detection results of the object detecting system, thereby enabling detailed control for the occupant restraining mechanism 210.

Furthermore, according to this embodiment, there is provided a vehicle mounted with the object detecting system 100 capable of conducting rational setting of the viewing field of the camera 112.

The present invention is not limited to the aforementioned embodiment and various applications and modifications may be made. For example, the following respective embodiments based on the aforementioned embodiment may be carried out.

In embodiments, the object to be detected through the camera 112 includes a vehicle occupant, an object placed on a vehicle seat, a child seat, and a junior seat. In this case, information about the object includes information about presence, the size, the position, and the attitude of the object.

Though the aforementioned embodiment has been described with regard to the arrangement of the object detecting system to be installed in an automobile, embodiments can be adopted to object detecting systems to be installed in various vehicles other than automobile such as an airplane, a boat, a train, a bus, a truck, and the like.

Japan Priority Application 2006-103626, filed Apr. 4, 2006 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An object detecting system for detecting information about objects on vehicle seats, comprising:
a camera for taking images from a single view point in a cabin of a vehicle toward a rear side of the vehicle; and
a processing mechanism for deriving information about the objects on the vehicle seats based on images taken by the camera,
wherein the viewing field of the camera covers an area defined between a first sight line extending from the single view point toward the rear side of the vehicle through a central area in the lateral direction of the driver seat and a second sight line extending from the single view point toward the rear side of the vehicle through a central area in the lateral direction of the front passenger seat.

2. The object detecting system as claimed in claim 1, wherein the viewing field of the camera defined between the first sight line and the second sight line covers an area of a rear seat.

3. The object detecting system as claimed in claim 1, wherein the viewing angle of the viewing field of the camera when seen from above is set to be lower than about 110 degrees.

4. The object detecting system as claimed in claim 1, wherein the processing mechanism detects respective halves of the object on the driver seat and the object on the front passenger seat based on the images obtained by the camera having the viewing field defined between the first sight line and the second sight line and thereby determines at least one of the presence, the size, the position, and the attitude of each object.

5. The object detecting system as claimed in claim 1, wherein each object on the vehicle seats is identified at least based on distances from the camera to the surface of the object or the three-dimensional profile of the object.

6. An operation device control system, comprising:
an object detecting system;
an operation device; and
an actuation control mechanism for controlling the actuation of the operation device,
wherein the object detecting system includes:
a camera for taking images from a single view point in a cabin of a vehicle toward a rear side of the vehicle; and
a processing mechanism for deriving information about the objects on the vehicle seats based on images taken by the camera,
wherein the viewing field of the camera covers an area defined between a first sight line extending from the single view point toward the rear side of the vehicle through a central area in the lateral direction of the driver seat and a second sight line extending from the single view point toward the rear side of the vehicle through a central area in the lateral direction of the front passenger seat, and
wherein the operation device is operated based on the information about the object on the vehicle seat derived by the processing mechanism of the object detecting system.

7. The operation device control system as claimed in claim 6, wherein the viewing field of the camera defined between the first sight line and the second sight line covers an area of a rear seat.

8. The operation device control system as claimed in claim 6, wherein the viewing angle of the viewing field of the camera when seen from above is set to be lower than about 110 degrees.

9. The operation device control system as claimed in claim 6, wherein the processing mechanism detects respective halves of the object on the driver seat and the object on the front passenger seat based on the images obtained by the camera having the viewing field defined between the first sight line and the second sight line and thereby determines at least one of the presence, the size, the position, and the attitude of each object.

10. The operation device control system as claimed in claim 6, wherein each object on the vehicle seats is identified at least based on distances from the camera to the surface of the object or the three-dimensional profile of the object.

11. A vehicle, comprising:
an engine/running system;
an electrical system;
an actuation control device for conducting the actuation control of the engine/running system and the electrical system; and
an object detecting mechanism for detecting information about objects on vehicle seats,
wherein the object detecting mechanism comprises an object detecting system that includes:
a camera for taking images from a single view point in a cabin of a vehicle toward a rear side of the vehicle; and
a processing mechanism for deriving information about the objects on the vehicle seats based on images taken by the camera,
wherein the viewing field of the camera covers an area defined between a first sight line extending from the single view point toward the rear side of the vehicle through a central area in the lateral direction of the driver seat and a second sight line extending from the single view point toward the rear side of the vehicle through a central area in the lateral direction of the front passenger seat.

12. The vehicle as claimed in claim 11, wherein the viewing field of the camera defined between the first sight line and the second sight line covers an area of a rear seat.

13. The vehicle as claimed in claim 11, wherein the viewing angle of the viewing field of the camera when seen from above is set to be lower than about 110 degrees.

14. The vehicle as claimed in claim 11, wherein the processing mechanism detects respective halves of the object on the driver seat and the object on the front passenger seat based on the images obtained by the camera having the viewing field defined between the first sight line and the second sight line and thereby determines at least one of the presence, the size, the position, and the attitude of each object.

15. The vehicle as claimed in claim 11, wherein each object on the vehicle seats is identified at least based on distances from the camera to the surface of the object or the three-dimensional profile of the object.

16. An object detecting method for detecting information about objects on vehicle seats, comprising:
positioning a camera in a vehicle;
setting a viewing field of the camera to cover an area defined between a first sight line extending from a single view point toward the rear side of the vehicle through a central area in the lateral direction of the driver seat and a second sight line extending from the single view point toward the rear side of the vehicle through a central area in the lateral direction of the front passenger seat so that the viewing field is allocated to cover respective halves of an object on the driver seat and an object on the front passenger seat; and
taking images with the camera from the single view point in a cabin of a vehicle toward a rear side of the vehicle.

17. The object detecting method as claimed in claim 16, wherein, as regards the setting of the camera, the viewing field of the camera defined between the first sight line and the second sight line covers an area of a rear seat.

18. The object detecting method as claimed in claim 16, wherein, as regards the setting of the camera, the viewing angle of the viewing field of the camera when seen from above is set to be lower than about 110 degrees.

19. The object detecting method as claimed in claim 16, wherein respective halves of the object on the driver seat and the object on the front passenger seat are detected based on the images obtained by the camera having the viewing field defined between the first sight line and the second sight line and at least one of the presence, the size, the position, and the attitude of each object is determined based on the detected halves.

20. The object detecting method as claimed in claim 16, wherein each object on the vehicle seats is identified at least based on distances from the camera to the surface of the object or the three-dimensional profile of the object.
